(19) United States
(12) Patent Application Publication
(10) Pub. No.: US 2003/0152386 A1
(43) Pub. Date: Aug. 14, 2003

(54) Efficient multi-format optical transport of broadband signals for DWDM cable TV networks

(76) Inventors: Sandeep T. Vohra, Ellicott City, MD (US); Paul J. Matthews, Ellicott City, MD (US); Irl N. Duling, Lancaster, PA (US)

Correspondence Address: PILLSBURY WINTHROP, LLP, P.O. BOX 10500, MCLEAN, VA, 22102, US

(21) Appl. No.: 10/308,199

(22) Filed: Dec. 3, 2002

Related U.S. Application Data
(60) Provisional application No. 60/334,954, filed on Dec. 4, 2001.

(51) Int. Cl. H04J 14/00

(52) U.S. Cl. 398/76; 398/79

(57) ABSTRACT

Arrangements are provided for multi-format information optical transport. A multi-format optical signal transport generator is designed to generate a multi-format optical signal based on information in different formats from heterogeneous information sources. Such generated multi-format optical signal is optically transported via an optical fiber. Upon receiving the optical at a receiving end, a multi-format optical signal transport receiver decodes the multi-format optical signal to recover the information of different formats.

This Application is based on Provisional Application No. 60/334,954 filed Dec. 4, 2001, the entire contents of which is hereby incorporated by reference.

### BACKGROUND

1. Field of Invention

The present invention relates to systems and methods for transporting information of different formats via optical networks and optical networks employing such systems and methods.

2. Discussion of Related Art

The increasing demand for optical communication systems is no longer just for faster and more reliable broadband networks. Such a demand is more and more so related to the desire to offer and receive bundled services on a single medium and from a single service provider. On one hand, to achieve faster and more reliable broadband data transportation, wavelength division multiplexing (WDM) is a technique used to increase the capacity of optical communication systems. Such optical communication systems include, but are not limited to, telecommunication systems, cable television systems (CATV), and local area networks (LANs). An introduction to the field of Optical Communications can be found in “Optical Communication Systems” by Gowar, ed. Prentice Hall, NY, 1993.

WDM optical communication systems carry multiple optical signal channels, each channel being assigned a different wavelength. Optical signal channels are generated, multiplexed to form an optical signal comprised of the individual optical signal channels, and transmitted over a single waveguide such as an optical fiber. The optical signal is subsequently demultiplexed such that each individual channel can be routed to a designated receiver.

On the other hand, bundled services such as video, high speed Internet traffic, video on demand, voice, and interactive gaming involve information from sources that are heterogeneous in nature and each usually delivers corresponding information in a different format. For example, video information is often in MPEG (Moving Picture Expert Group) or M-JPEG (Motion-Joint Photographic Experts Group) format. Voice information may be encoded based on SONET (synchronous optical networks) or ATM (asynchronous transport mode) protocol. Internet traffic is in general in Ethernet format. An information transport solution related to a particular service is conventionally optimized individually for the underlying service. For example, voice services have been optimized using on-off-keyed format with SONET protocol, while Internet protocol (IP) used to transmit Internet traffic is designed for packet or Ethernet transport.

To deliver bundled services from a single service provider, it is possible to transport information relating to different services on a single platform. For instance, information related to different services may all be transported using a single protocol such as SONET. However, transporting all information using SONET can be inefficient and cost prohibitive. Required format conversions may further drive up the cost and introduce inefficiency. Therefore, transporting multi-format information for bundled services using a single platform often leads to performance degradation. This becomes particularly true when the number of services involved increases.

To facilitate coherent connectivity and consolidation of information of multiple formats, it is of paramount importance to devise appropriate transport solutions which enable broadband bundled services in a cost effective and efficient manner.

### SUMMARY

In accordance with the present invention, a method is provided for multi-format information transport. Information of multiple formats from heterogeneous sources may be both RF sub-carrier multiplexed and optical-carrier multiplexed and is transported to corresponding heterogeneous destinations via an optical network. Different aspects of the invention relate to a multi-format optical signal transport generator at a transmitting end of an optical multi-format information transport framework and a multi-format optical signal transport receiver at a receiving end of the optical multi-format information transport framework.

In one embodiment of the present invention, multi-format information, such as video, IP, video games, and telephony, is received from appropriate devices such as a video server, an IP router, or a voice switch. The multi-format optical signal transport generator up-converts the multi-format information onto different RF sub-carriers which are then multiplexed to produce a single sub-carrier multiplexed, multi-format RF signal. To enable optical transport, the multi-format optical signal transport generator further up-converts the sub-carrier multiplexed, multi-format RF signal onto an optical carrier with a certain wavelength to produce a multi-format optical signal. Such an optical signal carries the multi-format information from heterogeneous sources and can be optically transported in an optical network.

In some embodiments of the present invention, video information may be encoded prior to being up-converted onto corresponding RF sub-carriers. In a preferred embodiment, a multi-level encoding scheme may be employed to encode video information before up-converting the video information onto designated RF sub-carriers. Quadrature amplitude modulation (QAM) may be used to implement multi-level encoding.

In other embodiments, multi-level encoding may be applied to multi-format information from more than one source before such information is up-converted to corresponding RF sub-carriers. In one embodiment, multi-level encoding is applied to both video information and IP information. In a different embodiment, multi-level encoding is applied to both video information and voice information. In another different embodiment, multi-level encoding is applied to video information, IP information, and voice information.

In another embodiment, multi-format information may be multiplexed before the multi-level encoding is performed. Different video streams may be multiplexed first and the combined video information streams can then be encoded using a multi-level encoding scheme.

In yet another embodiment, the multi-format optical signal transport generator is capable of further aggregating information by multiplexing a plurality of optical signals carried on optical carriers with different wavelengths to increase the total transmission capacity. A plurality of multi-format optical signal generation devices may be deployed, each of which generates an optical signal based on multi-format information from heterogeneous sources using a designated optical carrier with a distinct wavelength. A wavelength division multiplexer or a dense wavelength division multiplexer multiplexes the optical signals from those multi-format optical signal generation devices to produce a single multi-format optical signal.

In accordance with another aspect of the present invention, a method for receiving multi-format optical signals at a receiving end of the multi-format optical transport framework is also provided. When multiple optical carriers are involved, a received multi-format optical signal is first demultiplexed into a plurality of optical signals. Each optical signal is processed by a corresponding multi-format optical signal receiving device.

In one embodiment of the multi-format optical signal receiving device, an optical signal is down-converted to produce a sub-carrier multiplexed, multi-format RF signal, which is then further split into a plurality of RF signals corresponding to different RF sub-carriers. The RF signals on different RF sub-carriers are then down-converted to recover the multi-format information. Such recovered multi-format information is then directed to appropriate destinations according to their underlying formats.

In different embodiments, multi-level decoding may be applied after the multi-format information is down-converted from corresponding RF sub-carriers. In one embodiment, multi-level decoding is applied to video information. In a different embodiment, multi-level decoding is applied to both video information and IP information. In another embodiment, multi-level decoding is applied to both video information and voice information. In yet another different embodiment, multi-level decoding can be applied to video information, IP information, and voice information.

### BRIEF DESCRIPTION OF THE DRAWINGS

The invention as claimed and/or described herein is further described in terms of exemplary embodiments. These exemplary embodiments are described in detail with reference to the drawings. These embodiments are non-limiting exemplary embodiments, in which like reference numerals represent similar parts throughout the several views of the drawings, and wherein:

FIG. 1 depicts a first exemplary architecture for generating a sub-carrier multiplexed, multi-format optical signal according to embodiments of the present invention;

FIG. 2 illustrates an exemplary distribution of different RF sub-carriers and how they may be designated for information from different heterogeneous sources, according to embodiments of the present invention;

FIG. 3 depicts a second exemplary architecture for generating a sub-carrier multiplexed, multi-format optical signal using multi-level encoding according to embodiments of the present invention;

FIG. 4 depicts an exemplary detailed internal structure for generating a sub-carrier multiplexed, multi-format optical signal using the multi-level encoding mechanism according to embodiments of the present invention;

FIG. 5 illustrates an exemplary internal structure of an optical modulator;

FIG. 6 depicts a third exemplary architecture for generating a sub-carrier multiplexed, multi-format optical signal using multi-level encoding according to embodiments of the present invention;

FIG. 7 depicts a fourth exemplary architecture for generating a sub-carrier multiplexed, multi-format optical signal using multi-level encoding according to embodiments of the present invention;

FIG. 8 depicts a fifth exemplary architecture for generating a sub-carrier multiplexed, multi-format optical signal using multi-level encoding according to embodiments of the present invention;

FIG. 9 depicts a seventh exemplary architecture for generating a sub-carrier multiplexed, multi-format optical signal for optical transport according to embodiments of the present invention;

FIG. 10 depicts an exemplary architecture for decoding a sub-carrier-multiplexed multi-format optical signal at a receiving end of an optical transport according to embodiments of the present invention;

FIG. 11 depicts an exemplary detailed internal structure for decoding a sub-carrier multiplexed, multi-format signal at a receiving end according to embodiments of the present invention; and

FIG. 12 depicts an exemplary architecture for optical transport of multi-format information according to embodiments of the present invention.

### DETAILED DESCRIPTION

The present invention provides a framework for optically transporting information of multiple formats. Information of multiple formats from heterogeneous sources may be both RF sub-carrier multiplexed and optical-carrier multiplexed to generate an optical signal. Such generated optical signal is transported, via an optical fiber, to be delivered to corresponding heterogeneous destinations. Different aspects of the invention relate to a multi-format optical signal transport generator at a transmitting end of an optical multi-format information transport framework and a multi-format optical signal transport receiver at a receiving end of the optical multi-information transport framework.

The multi-format optical signal transport generator may be realized using a wavelength division multiplexer that combines a plurality of optical signals in different wavelength channels. The plurality of optical signals are generated by corresponding multi-format optical signal generation mechanisms, each of which produces an optical signal in an optical channel with a certain wavelength based on RF sub-carrier multiplexed signals.

The multi-format optical signal transport receiver may be realized using a wavelength division multiplexer that splits a WDM optical signal into a plurality of spatially separated optical signals corresponding to the WDM wavelength channels. The optical signals in different wavelength channels are further processed by corresponding multi-format optical signal receiving mechanisms, each of which recovers multi-format information based on RF sub-carrier demultiplexing. The recovered multi-format information is then directed to appropriate destinations.

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, computer-readable media may comprise any form of data storage mechanism, including such existing memory technologies as well as hardware or circuit representations of such structures and of such data.

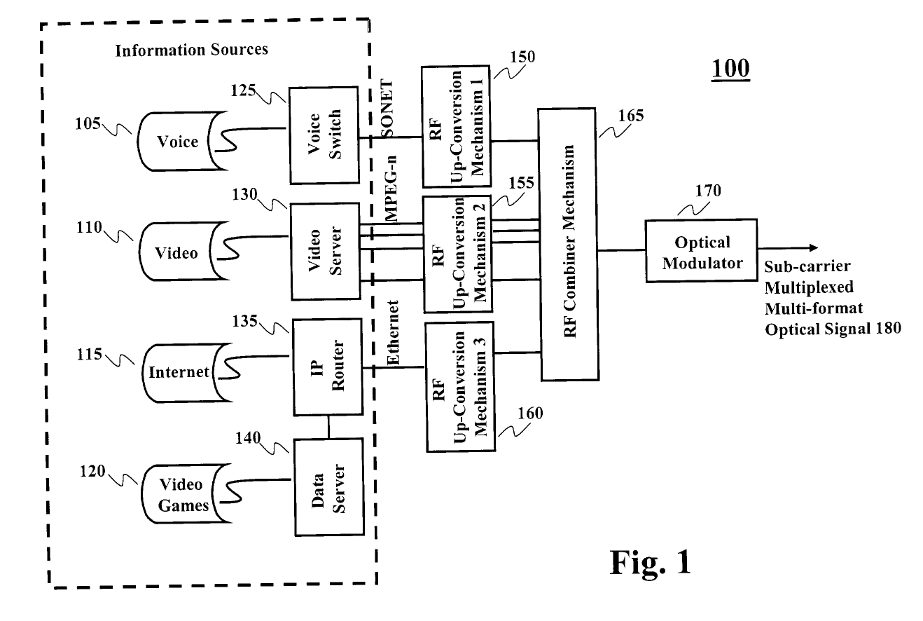

FIG. 1 depicts a first exemplary architecture 100 for generating a sub-carrier multiplexed, multi-format optical signal 180, according to embodiments of the present invention. The architecture 100 comprises a plurality of information sources that provide information in different formats, a plurality of radio frequency (RF) up-conversion mechanisms (e.g., RF up-conversion mechanism 1 150, RF up-conversion mechanism 2 155, and RF up-conversion mechanism 3 160) to up-convert information in different formats onto RF sub-carriers, an RF combiner mechanism 165 to multiplex RF signals on different sub-carriers, and an optical modulator 170 to up-convert a sub-carrier multiplexed, multi-format RF signal onto an optical carrier to generate the sub-carrier multiplexed, multi-format optical signal 180.

Information in different formats may be from a plurality of information sources (e.g., voice information 105, video information 110, Internet information 115, . . . , and video game information 120) and is directed to corresponding RF up-conversion mechanisms via appropriate devices. For instance, the voice information 105 is directed via a voice switch 125, the video information 110 is directed via a video server 130, the Internet information 115 is directed via an Internet Protocol (IP) router 135, . . . , and the video game information 120 is directed via a data server 140.

Information from different sources are in different formats. For example, the voice information 105 directed from the voice switch 125 may be in a SONET format. The video information 110 directed from the video server 130 may be in one of the MPEG formats such as MPEG-2 or MPEG-4. The video information 110 may also be in other formats such as M-JPEG (Motion Joint Photographic Experts Group) (not shown in FIG. 1). In addition, the IP router 135 may direct either the Internet information 115 or the video game information (from the data server 140) in an Ethernet format.

Each of the RF up-conversion mechanisms (i.e., 150, 155, and 160) may up-convert information in a particular format onto some pre-defined RF sub-carrier(s). One may also employ agile RF up-/down-conversion without departing from the scope of this invention. In the following detailed description, the terms “upconverter” and “downconverter” is not limited to specific types of up/downconverters. They may be of any generally accepted design (i.e. single, double, triple, etc. stage). Many upconverters are actually an up-upconversion process. Similarly for down-converters

In the architecture 100, the RF up-conversion mechanism 1 150 is responsible for up-converting the voice information 105 in SONET format onto a pre-defined RF sub-carrier. The RF up-conversion mechanism 2 155 is responsible for up-converting various streams of the video information 110 in MPEG-n format or in M-JPEG format onto appropriate RF sub-carriers, where the MPEG-n format may include MPEG-1, MPEG-2, or MPEG-4. The RF up-conversion mechanism 160 is responsible for up-converting the Internet information 115 from the IP router 135 onto a pre-determined RF sub-carrier.

Information from a particular information source may comprise one or more information streams. For instance, the voice information 105 directed through the voice switch 125 may include only one information stream at any given time. Yet, the video information 110 from the video server 130 may include multiple information streams. In the architecture 100, each information stream may be up-converted onto a distinct RF sub-carrier. Alternatively, different streams may also be multiplexed (not shown) before they are up-converted to an RF sub-carrier.

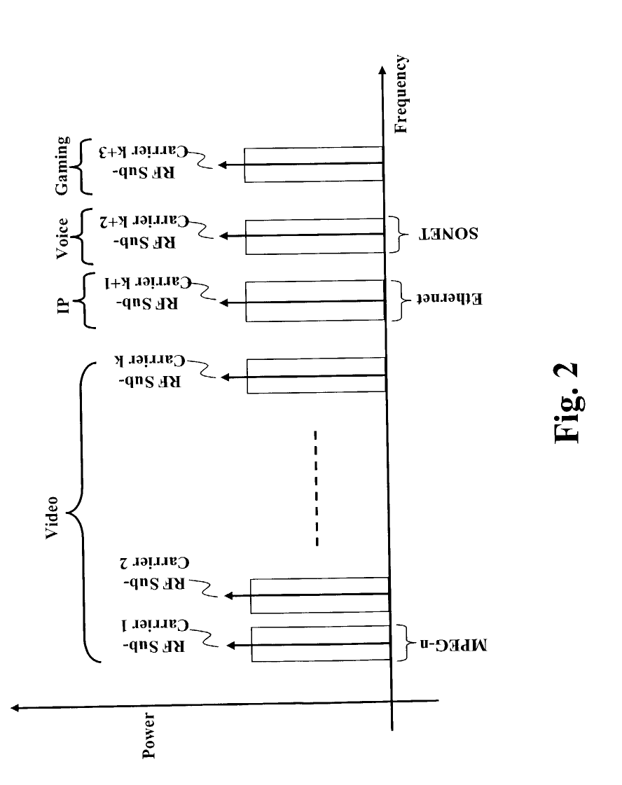

FIG. 2 illustrates an exemplary distribution of different RF sub-carriers and how they may be designated for information from different heterogeneous sources, according to embodiments of the present invention. Each RF sub-carrier illustrated in FIG. 2 may correspond to a different frequency with a certain bandwidth. The spike located in the center of a block in FIG. 2 may represent the frequency of the underlying RF sub-carrier and the width of the block may represent the bandwidth. Each RF sub-carrier may be designated to carry a specific information stream in a particular format. For instance, a plurality of RF sub-carriers (e.g., RF sub-carrier 1 through RF sub-carrier k in FIG. 2) may be designated for video information 110 and each of these RF sub-carriers may be used for one video stream (or many if previously multiplexed at baseband) which may be in either an MPEG-n format or a M-JPEG format.

Correspondingly, an RF sub-carrier (e.g., RF sub-carrier k+1) may be designated to carry the IP information 115 encoded in the Ethernet format. A different RF sub-carrier (e.g., RF sub-carrier k+2) may be designated to carry the voice information 110 in a SONET format. Yet another RF sub-carrier (e.g., RF sub-carrier k+3) may be used to carrying the gaming information 120 in corresponding IP format.

Different RF sub-carriers carrying information in different formats are then multiplexed or combined via the RF combiner mechanism 165 to produced a sub-carrier multiplexed RF signal. To transport this sub-carrier multiplexed RF signal via an optical fiber, the optical modulator 170 up-converts the sub-carrier multiplexed RF signal onto an optical carrier of a particular wavelength to produce a single optical signal.

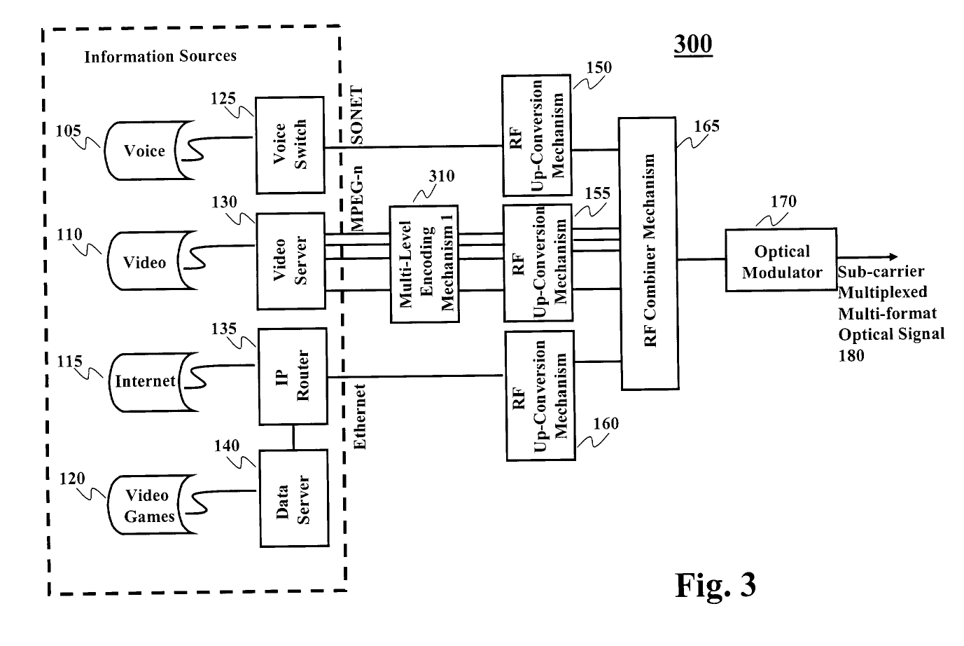

FIG. 3 depicts a second exemplary architecture 300 for generating a sub-carrier multiplexed, multi-format optical signal using multi-level encoding, according to embodiments of the present invention. In this embodiment, the video information 110 is first multi-level encoded prior to being up-converted onto RF sub-carriers. The architecture 300 comprises the same components as in the architecture 100 except that it also includes a multi-level encoding mechanism 310 which encodes the video information 110 based on a multi-level encoding scheme. A multi-level encoding scheme allows information streams to be further aggregated. Various techniques known in the art may be used to implement multi-level encoding. For example, quadrature amplitude modulation (QAM) may be used to realize multi-level encoding of the video information 110.

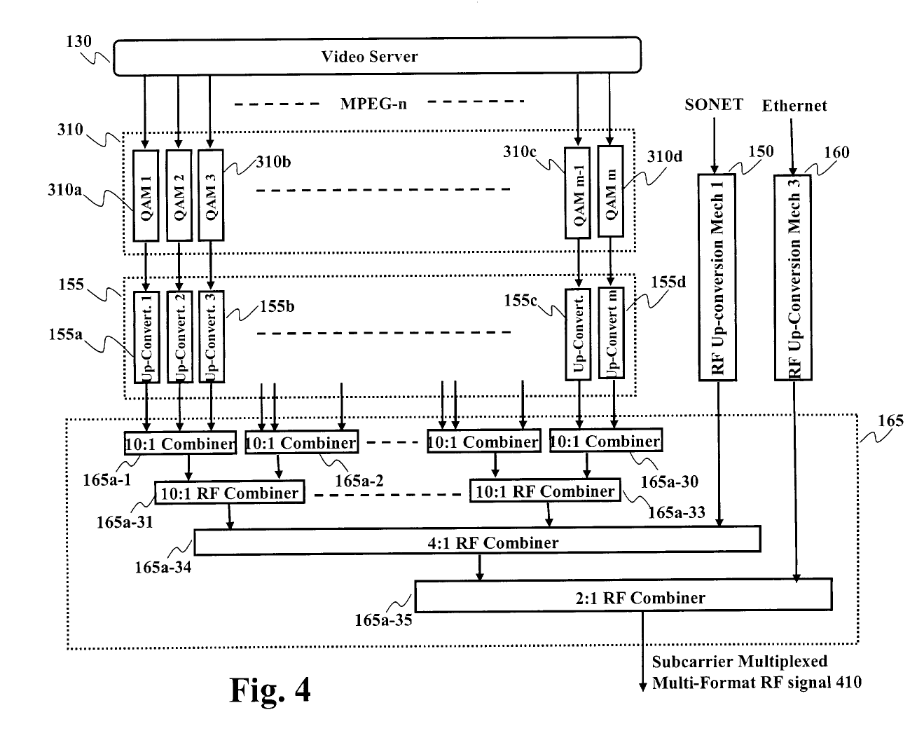

FIG. 4 depicts an exemplary detailed internal structure for generating a sub-carrier multiplexed, multi-format optical signal using the multi-level encoding mechanism 310, according to embodiments of the present invention. The video server 130 feeds the video information 110 to the multi-level encoding mechanism 310. The multi-level encoding mechanism 310 comprises a plurality of QAMs (e.g., QAM 1 310a, . . . , QAM 3 310b, . . . , QAM m−1 310c, and QAM m 310d), each of which may encode one stream of video information and generate a quadrature amplitude modulated signal. It is also possible for each quadrature amplitude modulator to encode more than one stream of video information if different information streams (e.g., different video streams) are multiplexed (not shown) prior to quadrature amplitude modulation.

The quadrature amplitude modulated signals from the QAMs are fed into the RF up-conversion mechanism 155, which includes a plurality of RF up-converters (e.g., an RF up-converter 1 155a, . . . , an RF up-converter 3 155b, . . . , an RF up-converter m−1 155c, and an RF up-converter m 155d). Each of the RF up-converters takes one quadrature amplitude modulated signal and up-converts the signal onto an RF sub-carrier to produce an RF signal. The multiple RF signals produced by the RF up-conversion mechanism 155 are then combined by the RF combiner mechanism 165.

Depending on the number of RF signals and the combiners deployed, the RF combiner mechanism 165 may be structured differently. For instance, if the number of RF signals is K, a K:1 combiner may be used to multiplex the K RF signals into one RF signal. However, when K is large, a plurality of combiners may be used to multiplex the K RF signals at different stages. In FIG. 4, an exemplary hierarchical structure of the RF combiner mechanism 165 is illustrated. Multiple combiners may be used at different levels of the hierarchy.

In the illustrated embodiment, if there are 300 RF signals (e.g., 300 or more streams of video information), thirty 10:1 combiners can be deployed at the first level of the hierarchy (e.g., 165a-1, . . . , 165a-30), producing 30 sub-carrier multiplexed RF signals as output of the first level. Such RF signals may be further multiplexed at higher levels. For instance, to further combine the 30 RF signals from the first level of multiplexing, three 10:1 combiners (e.g., 165a-31, . . . , 165a-33) are used at the second level of the hierarchy to produce 3 multiplexed RF signals.

To combine the three sub-carrier multiplexed RF signals from the video information 110 with the voice information in a different format (e.g., SONET) from the RF up-conversion mechanism 150, a 4:1 combiner (e.g., 165a-34) may be used at the third level of the hierarchy to produce a multiplexed multi-format RF signal. This multiplexed multi-format RF signal is subsequently combined with the RF signal encoded with the Internet information 115 or 120 in Ethernet format from the RF up-conversion mechanism 3 160 using a 2:1 combiner (e.g., 165a-35) at the top level of the hierarchy. This produces a final sub-carrier multiplexed, multi-format RF signal 410.

A combiner may be implemented using various known techniques in the art. In addition, combiners at a lower level in the hierarchy (e.g., combiners 165a-1, . . . , combiner 165a-30) may deal with input signals carried on RF sub-carriers of a same underlying frequency (i.e., same sub-carrier). In this case, frequency shifters may be employed to first shift different RF signals carried on the same frequency onto different frequencies prior to combining the RF signals.

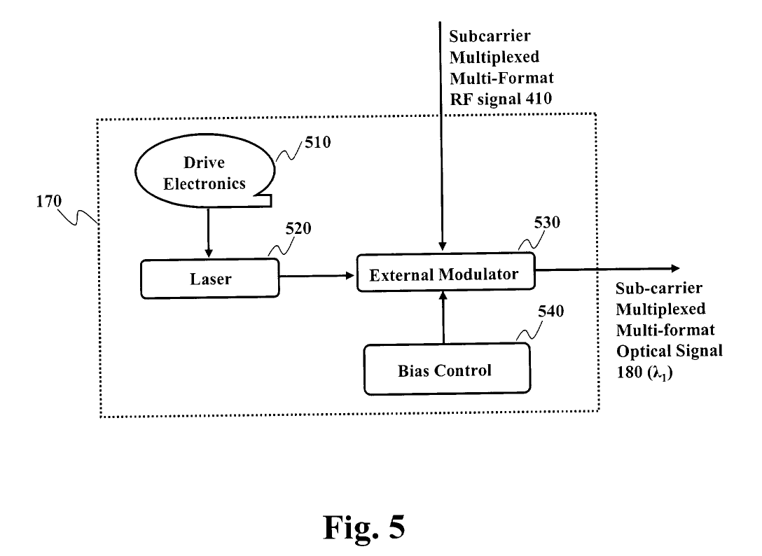

To transport the sub-carrier multiplexed, multi-format RF signal 410 via an optical fiber, the optical modulator 170 (see FIG. 3) is designed to up-convert the RF signal 410 onto an optical carrier with a certain wavelength. FIG. 5 illustrates an exemplary internal structure of the optical modulator 170. The exemplary optical modulator 170 comprises drive electronics 510, a laser 520, an external modulator 530, and a bias control 540. The drive electronics 510 comprises electronics that drive the laser 520. The laser 520 generates a certain wavelength carrier (e.g., λ₁). The external modulator 530 takes the sub-carrier multiplexed, multi-format RF signal 410 as input and modulates this RF signal onto the optical carrier produced by the laser 520. During the modulation, the bias control 540 may impose some pre-determined bias. An example of an external modulator is a Mach-Zehnder interferometer. Furthermore, one may also use direct modulation of the laser without departing from the scope of this invention. The optical modulation process produces the sub-carrier multiplexed, multi-format optical signal 180 corresponding to an optical carrier with a certain wavelength (e.g., λ₁).

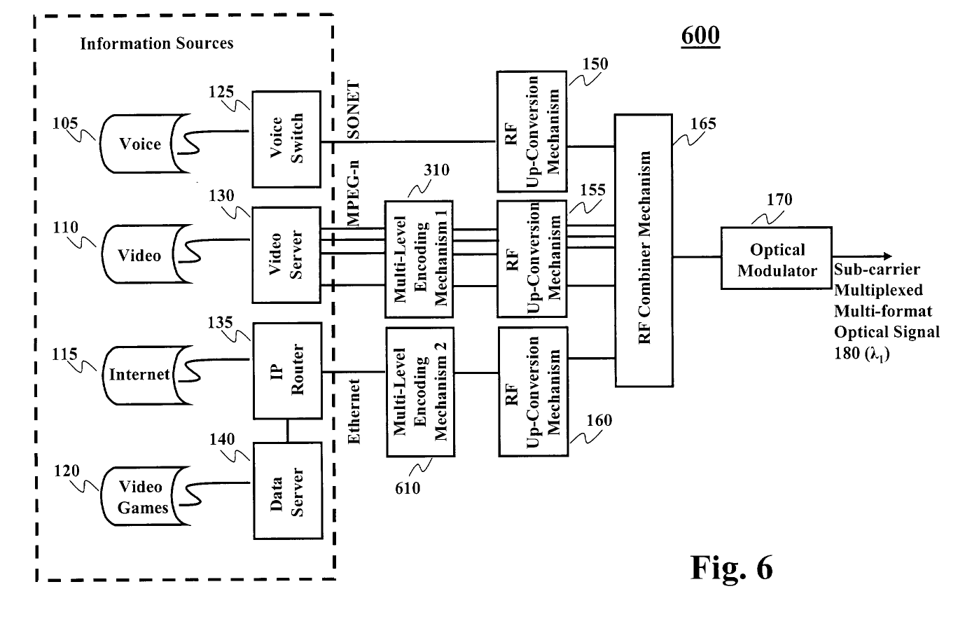

FIG. 3 depicts an architecture in which multi-level encoding is applied on the video information 110. FIGS. 6-8 describe other alternative embodiments where multi-level encoding may be applied to different types of information. FIG. 6 depicts a third exemplary architecture 600 for generating a sub-carrier multiplexed, multi-format optical signal where multi-level encoding is applied to both the video information 110 and the information in Ethernet format such as the Internet information 115 and the video game information 120, according to embodiments of the present invention.

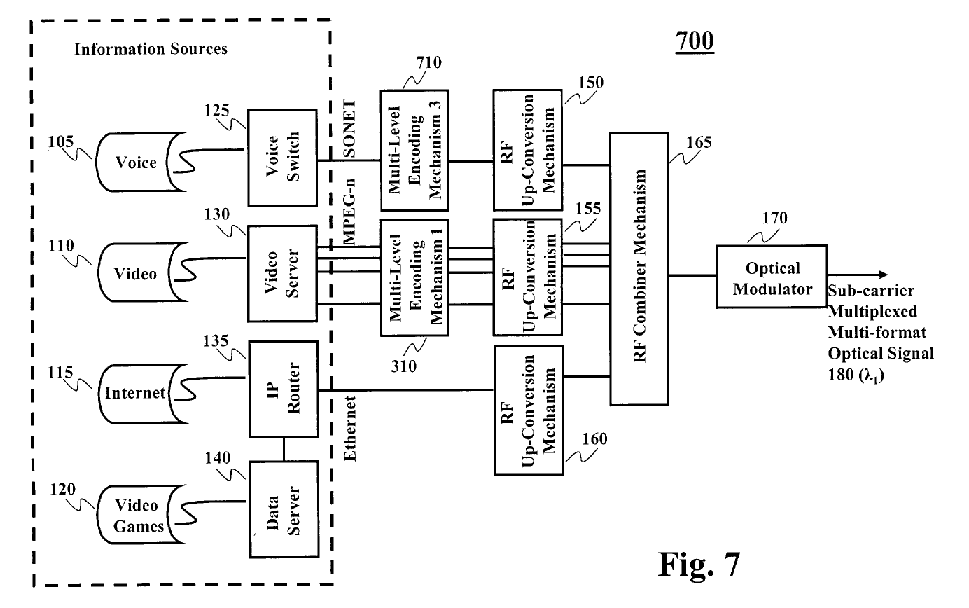

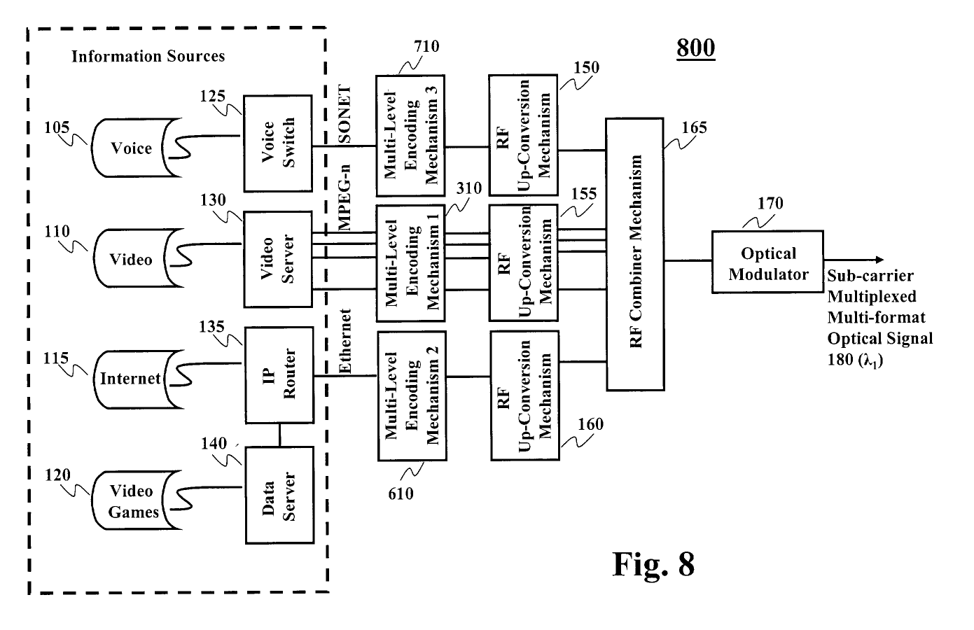

FIG. 7 depicts a fourth exemplary architecture 700 for generating a sub-carrier multiplexed, multi-format optical signal where multi-level encoding is applied to both the video information 110 and the voice information 105 in SONET format, according to embodiments of the present invention. FIG. 8 depicts a fifth exemplary architecture 800 for generating a sub-carrier multiplexed, multi-format optical signal using multi-level encoding of information from all information sources, according to embodiments of the present invention.

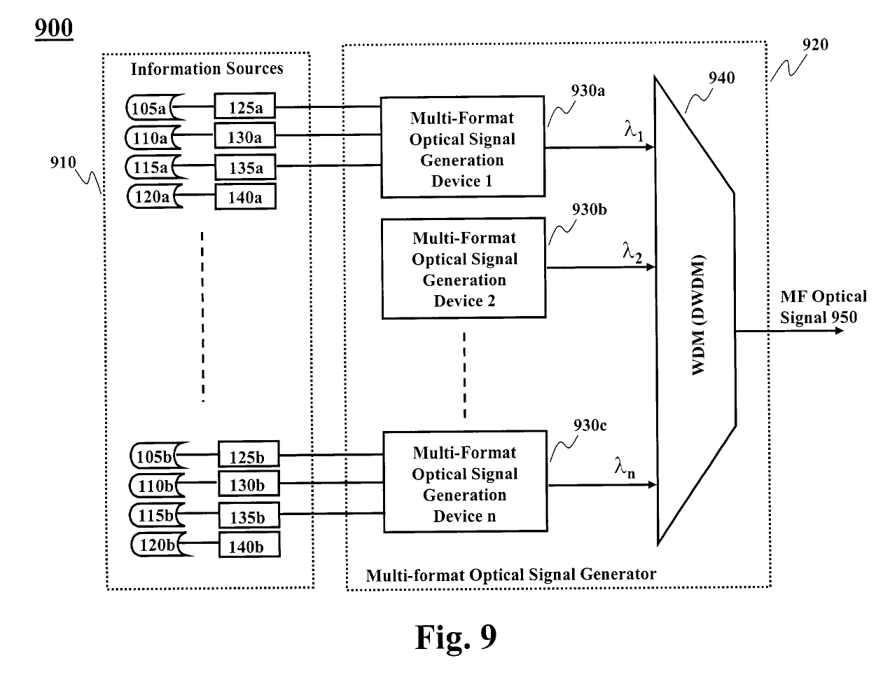

FIG. 9 depicts an exemplary architecture 900 for aggregating a plurality of sub-carrier multiplexed, multi-format optical signals for efficient optical transport, according to embodiments of the present invention. The architecture 900 comprises a plurality of information sources 910 and a multi-format optical signal transport generator 920. The multi-format optical signal transport generator 920 further comprises a plurality of multi-format optical signal generation mechanisms (e.g., a multi-format optical signal generation mechanism 1 930a, a multi-format optical signal generation mechanism 2 930b, . . . , a multi-format optical signal generation mechanism n 930c) and a wavelength division multiplexer (or a dense wavelength division multiplexer) 940.

Each multi-format optical signal generation mechanism (e.g., the multi-format optical signal generation mechanism 1 930a) can be, but is not limited to, any of the embodiments described with reference to FIGS. 3-8. It receives information in different formats from different information sources and produces a sub-carrier multiplexed, multi-format optical signal on a pre-determined optical carrier with a certain wavelength (e.g., wavelength λ₁).

Different multi-format optical signal generation mechanisms in FIG. 9 may produce sub-carrier multiplexed, multi-format optical signals on optical carriers corresponding of distinct wavelengths. For instance, the multi-format optical signal generation mechanism 1 930a may produce an optical signal using an optical carrier of wavelength λ₁ based on information from information sources 125a (e.g., a voice switch), 130a (e.g., a video server), and 135a (e.g., an IP router). The multi-format optical signal generation mechanism n 930c may produce an optical signal using an optical carrier of wavelength λₙ based on information from information sources 125b (e.g., a different voice switch), 130b (e.g., a different video server), and 135b (e.g., a different IP router).

The wavelength division multiplexer 940 multiplexes different optical signals (carried on different optical carriers) generated by different multi-format optical signal generation mechanisms to produce a single multi-format (MF) optical signal 950. The final output optical signal 950 is produced based on multiplexing at different levels. For instance, information may first be multiplexed at baseband before being upconverted. The information is then multiplexed at the RF sub-carrier level as described with reference to FIG. 4. Such multiplexed RF signals can then be further multiplexed at the optical level after they are up-converted onto different optical carriers. In addition, as mentioned earlier, different information streams (e.g., different video streams) may also be multiplexed prior to multi-level encoding.

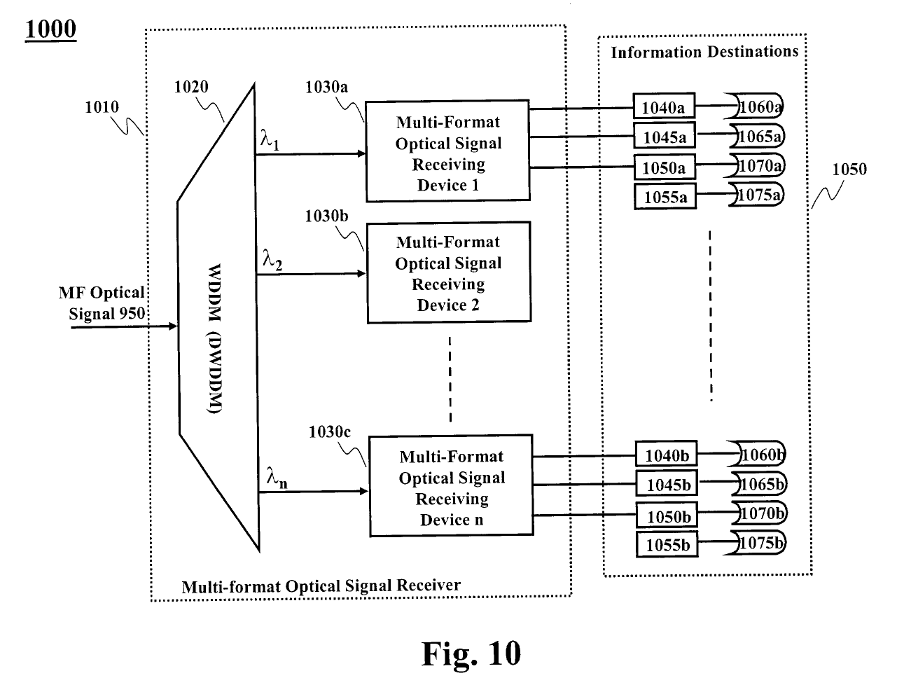

The multi-format optical signal 950, once generated, may be optically transported. At a destination, the received multi-format optical signal 950 may be correspondingly decoded in a manner according to how it is encoded. FIG. 10 depicts an exemplary architecture 1000 for decoding the multi-format optical signal 950 at a receiving end of an optical transport, according to embodiments of the present invention. In the architecture 1000, a multi-format optical signal transport receiver 1010 decodes the received multi-format optical signal 950 to recover information of different formats and directs decoded information in different formats to a plurality of information destinations (1050).

The multi-format optical signal transport receiver 1010 comprises a wavelength division demultiplexer (WDDM) 1020 and a plurality of multi-format optical signal receiving mechanisms (e.g., a multi-format optical signal receiving mechanism 1 1030a, a multi-format optical signal receiving mechanism 2 1030b, . . . , a multi-format optical signal receiving mechanism n 1030c). The WDDM demultiplexes the received multi-format optical signal 950 into a plurality of optical signals, each corresponding to an optical carrier at a different wavelength. The WDDM may correspondingly be a dense wavelength division demultiplexer.

The demultiplexed optical signals are then directed to different multi-format optical signal receiving mechanisms. For instance, the demultiplexed optical signal corresponding to an optical carrier with wavelength λ₁ may be directed to the multi-format optical signal receiving mechanism 1 1030a. The demultiplexed optical signal corresponding to an optical carrier with wavelength λ₂ may be directed to the multi-format optical signal receiving mechanism 2 1030b. The demultiplexed optical signal corresponding to an optical carrier with wavelength λₙ may be directed to the multi-format optical signal receiving mechanism n 1030c.

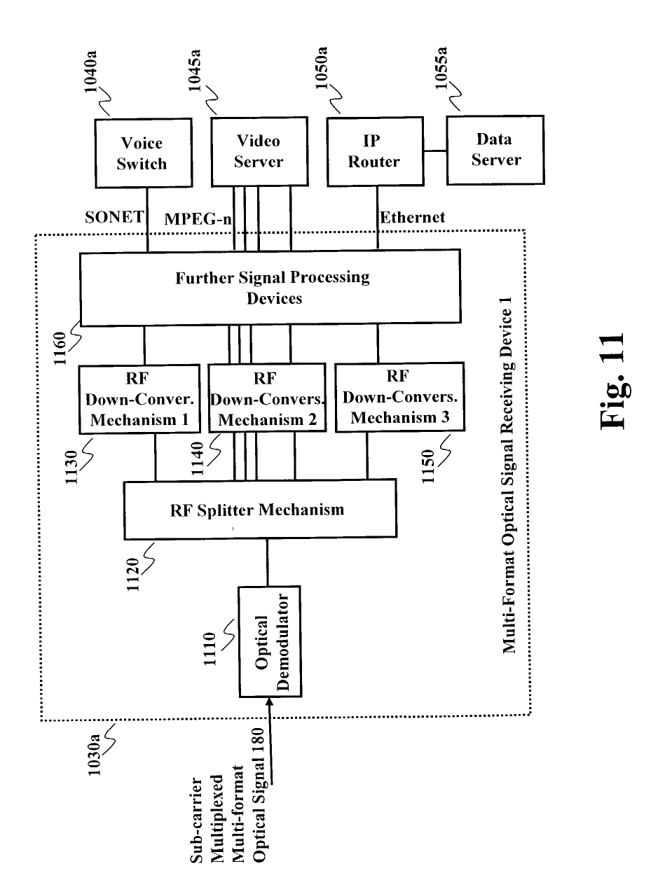

Each multi-format optical signal receiving mechanism may be designated to be responsible for delivering information to some pre-determined destinations. In FIG. 10, the multi-format optical signal receiving mechanism 1 1030a decodes an optical signal carried on wavelength λ₁ and forwards the decoded information to different destinations, including, for example, a voice switch 1040a, a video box 1045a connected to a video on demand (VoD) user, or an IP router 1055a connected to an Internet user or a video game player. FIG. 11 depicts an exemplary detailed internal structure of a multi-format optical signal receiving mechanisms (e.g., 1030a) in relation to different information destinations, according to embodiments of the present invention. Although the illustrated internal structure may represent a typical construct of a multi-format optical signal receiving mechanism, other alternative constructs may also be adopted to realize the functionalities of such receiving mechanisms.

The multi-format optical signal receiving mechanism 1 1030a comprises an optical demodulator 1110, an RF splitter mechanism 1120, a plurality of RF down-conversion mechanisms (e.g., an RF down-conversion mechanism 1 1130, an RF down-conversion mechanism 2 1140, and an RF down-conversion mechanism 3 1150), and an information direction mechanism 1160. The optical demodulator 1110, the RF splitter mechanism 1120, and the RF down-conversion mechanisms (i.e., 1130, 1140, and 1150) may perform reversed functions as what is described with respect to the optical modulator 170, the RF combiner mechanism 160, and the RF up-conversion mechanisms (150, 155, 160) in FIG. 1.

Specifically, the optical demodulator 1110 down converts an optical signal into an RF signal. The RF splitter mechanism 1120 demultiplexes the RF signal to produce a plurality of RF signals. Note that each output of the RF splitter contains all of the RF subcarriers on that particular optical wavelength. In this case, the selection process is done by default in the downconverter by throwing away the unused subcarriers not intended for that path. The selection is performed by the downconverter and any further routing functions may be performed by devices such as the IP router, voice switch, etc. Those RF signals are then directed to corresponding RF down-conversion mechanisms (1130, 1140, or 1150) to be converted to recover information in different formats. Further signal processing devices 1160 may be included after the RF downcoversion. A couple of possible further devices are QAM demodulators, and/or frequency translation devices.

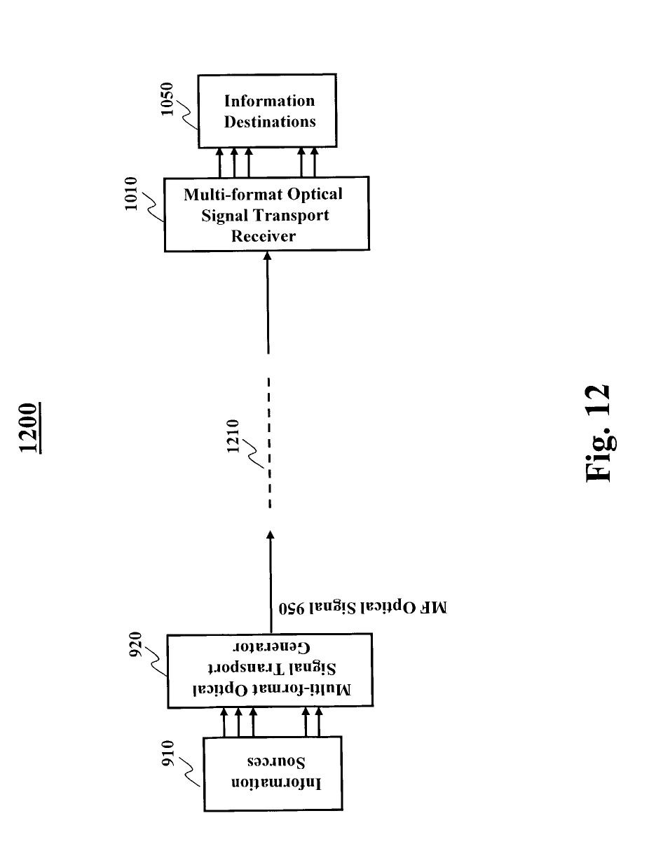

FIG. 12 depicts an exemplary framework 1200 for optically transporting multi-format information, according to embodiments of the present invention. The framework 1200 enables multi-format information from different sources (910) to be transported via an optical fiber 1210 to various destinations (1050). The multi-format optical signal transport generator 920 generates a single optical signal based on information in different formats from a variety of heterogeneous sources. Such information is processed in different stages (e.g., modulated and multiplexed at different levels) as described above to produce the multi-format optical signal 950.

The optical signal 950 is transported over the optical fiber 1210. Upon receiving the optical signal 950, the multi-format optical signal transport receiver 1010 processes the multi-format optical signal 950 in a number of stages (e.g., demultiplexes at different levels and demodulates) to recover information of different formats and then directs the information to appropriate destinations 1050.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and materials, such as are within the scope of the appended claims.

We claim:

1. A multi-format information transport device, comprising:
a multi-format optical signal transmitter;
an optical transmission fiber in communication with the multi-format optical signal transmitter; and
a multi-format optical signal receiver in communication with the multi-format optical signal transmitter via the optical transmission fiber, wherein
said multi-format optical signal transmitter is adapted to generate a multi-format optical signal based on information of different formats from different information sources and to transmit the multi-format optical signal, and
said multi-format optical signal receiver is adapted to decode the multi-format optical signal to recover the information of different formats.

2. The device according to claim 1, wherein the multi-format optical signal transmitter comprises:
at least one multi-format optical signal generation device; and
a wavelength division multiplexer in optical communication with the at least one multi-format optical signal generation device, wherein
each multi-format optical signal generation device is designed to encode the information in different formats from different information sources to produce a sub-carrier multiplexed, multi-format optical signal carried on an optical carrier of a distinct wavelength, and
said wavelength division multiplexer multiplexes different sub-carrier multiplexed, multi-format optical signals generated by the at least one multi-format optical signal generation device to produce a single multi-format optical signal.

3. The device according to claim 2, wherein the wavelength division multiplexer is a dense wavelength division multiplexer.

4. The device according to claim 2, wherein each multi-format optical signal generation device comprises:
a plurality of radio frequency (RF) up-converters, each of which being capable of up-converting information in an information format from an information source onto an RF sub-carrier to generate an RF signal;
an RF combiner capable of combining the RF signals generated by the RF up-converters to generate a sub-carrier multiplexed, multi-format RF signal; and
an optical modulator capable of up-converting the sub-carrier multiplexed, multi-format RF signal onto an optical carrier to generate a sub-carrier multiplexed, multi-format optical signal.

5. The device according to claim 1, wherein the multi-format optical signal receiver comprises:
a wavelength division demultiplexer; and
at least one multi-format optical signal receiving device in connection with the wavelength division demultiplexer, wherein
said wavelength division demultiplexer demultiplexes the received multi-format optical signal to produce a plurality of sub-carrier multiplexed, multi-format optical signals carried in different wavelength channels, and
each multi-format optical signal receiving device decodes one of the sub-carrier multiplexed, multi-format optical signals to recover information in different formats.

6. The device according to claim 5, wherein each multi-format optical signal receiving device comprises:
an optical demodulator capable of down-converting a sub-carrier multiplexed, multi-format optical signal to a sub-carrier multiplexed, multi-format RF signal;
an RF splitter capable of splitting the sub-carrier multiplexed, multi-format RF signal into a plurality of RF signals corresponding to different RF sub-carriers; and
a plurality of radio frequency (RF) down-converters, each of which being capable of down-converting an RF signal to recover information in an information format.

7. The device according to claim 1, wherein the information sources include at least a plurality of:
a video server capable of supplying video information;
a voice switch capable of supplying voice information; and
an Internet Protocol (IP) router capable of supplying Internet information.

8. The device according to claim 7, further comprising a data server capable of supplying information related to video games via the IP router.

9. The device according to claim 1, wherein the information format includes at least one of:
synchronous optical network (SONET) format;
Moving Picture Expert Group (MPEG) format;
Motion Joint Photographic Experts Group (M-JPEG) format;
Ethernet format;
asynchronous transfer mode (ATM) format;
voice over IP (VoIP) format; and
video over IP format.

10. A multi-format optical signal generation device, comprising:
a plurality of radio frequency (RF) up-converters;
an RF combiner connected to the plurality of RF up-converters; and
an optical modulator connected to the RF combiner device, wherein
each RF up-converter is adapted to up-convert information in an information format from an information source onto an RF sub-carrier to generate an RF signal,
the RF combiner is constructed to combine RF signals generated by the RF up-conversion devices to generate a sub-carrier multiplexed, multi-format RF signal, and
the optical modulator is adapted to up-convert the sub-carrier multiplexed, multi-format RF signal onto an optical carrier to generate a sub-carrier multiplexed, multi-format optical signal.

11. The device according to claim 10, wherein the information source includes at least a plurality of:
a video server capable of supplying video information;
a voice switch capable of supplying voice information; and
an Internet Protocol (IP) router capable of supplying Internet information.

12. The device according to claim 11, further comprising a data server capable of supplying information related to video games via the IP router.

13. The device according to claim 10, wherein the information format includes at least one of:
synchronous optical network (SONET) format;
moving picture expert group (MPEG) format;
Motion Joint Photographic Experts Group (M-JPEG) format;
Ethernet format;
asynchronous transfer mode (ATM) format;
voice over IP (VoIP) format; and
video over IP format.

14. The device according to claim 11, further comprising a first multi-level encoding mechanism, capable of performing multi-level encoding of the video information from the video server before the multi-level encoded video information is up-converted onto an RF sub-carrier.

15. The device according to claim 11, further comprising a second multi-level encoding mechanism, capable of performing multi-level encoding of the voice information from the voice switch before the multi-level encoded voice information is up-converted onto an RF sub-carrier.

16. The device according to claim 11, further comprising a third multi-level encoding mechanism, capable of performing multi-level encoding of the Internet information from the IP router before the multi-level encoded Internet information is up-converted onto an RF sub-carrier.

17. The device according to claim 14, wherein the multi-level encoding mechanism comprises at least one quadrature amplitude modulator (QAM).

18. The device according to claim 10, wherein each of the RF up-conversion mechanisms comprises at least one RF up-converter that up-converts a modulated signal onto an RF sub-carrier.

19. The device according to claim 10, wherein the RF combiner mechanism comprises at least one RF combiner, each of which combines a plurality of RF signals into one sub-carrier multiplexed RF signal.

20. The device according to claim 17, wherein the at least one combiner is organized in a hierarchical structure.

21. A multi-format optical signal receiving device, comprising:
an optical demodulator;
an RF splitter in connection with the optical demodulator; and
a plurality of radio frequency (RF) down-converters in communication with the RF splitter, wherein
said optical demodulator is adapted to down-convert a sub-carrier multiplexed optical signal to produce a sub-carrier multiplexed, multi-format RF signal,
said RF splitter is constructed to split the sub-carrier multiplexed, multi-format RF signal into a plurality of RF signals on corresponding RF sub-carriers, and
each of said RF down-converters converts an RF signal corresponding to an RF sub-carrier to produce information in an information format.

22. The device according to claim 21, wherein the information format includes at least one of:
synchronous optical network (SONET) format;
moving picture expert group (MPEG) format;
Motion Joint Photographic Experts Group (M-JPEG) format;
Ethernet format;
asynchronous transfer mode (ATM) format;
voice over IP (VoIP) format; and
video over IP format.

23. The device according to claim 21, further comprising a post-downconversion signal processing device.

24. The device according to claim 21, further comprising a first multi-level decoding device, capable of performing multi-level decoding of video information after the video information is down-converted from an RF sub-carrier.

25. The device according to claim 21, further comprising a second multi-level decoding device, capable of performing multi-level decoding of voice information after the voice information is down-converted from an RF sub-carrier.

26. The device according to claim 21, further comprising a third multi-level decoding device, capable of performing multi-level decoding of Internet information after the Internet information is down-converted from an RF sub-carrier.

27. The device according to claim 24, wherein the multi-level decoding device comprises at least one quadrature amplitude demodulator (QADM).

28. The device according to claim 21, wherein each of the RF down-conversion mechanisms comprises at least one RF down-converter that down-converts an RF signal carried by an RF sub-carrier to recover information in a certain format.

29. The device according to claim 21, wherein the RF splitter comprises at least one RF splitter, each of which splits a sub-carrier multiplexed RF signal into a plurality of RF signals.

30. The device according to claim 27, wherein the at least one splitter is organized in a hierarchical structure.

31. A method of transmitting information in an optical communication system, comprising:
up-converting a first signal having a first information format onto a first RF carrier;
up-converting a second signal having a second information format onto a second RF carrier;
multiplexing said first and second up-converted signals to provide a sub-carrier multiplexed signal;
modulating an optical carrier with said sub-carrier multiplexed signal to generate an optical signal; and
transmitting said optical signal from a first location to a second location.

32. The method according to claim 31, wherein each of said first and second formats are one of:
a synchronous optical network (SONET) format;
a moving picture expert group (MPEG) format;
a Motion Joint Photographic Experts Group (M-JPEG) format;
an Ethernet format;
an asynchronous transfer mode (ATM) format;
a voice over IP (VoIP) format; and
video over IP format.
